(19) United States
(12) Patent Application Publication
(10) Pub. No.: US 2026/0221681 A1
(43) Pub. Date: Jul. 30, 2026

(54) BOARD-TO-BOARD ARRAY CONNECTOR

(71) Applicant: Molex, LLC, Lisle, IL (US)

(72) Inventors: Jason E. Deren, West Hartford, CT (US); Brian P. O'Malley, Martinsville, IN (US); Jean-Louis Mendes, Staffanstorp (SE); Bharath Dattatri Bharadwaj, Bengaluru (IN); William E. Spink, Jr., Zionsville, IN (US)

(21) Appl. No.: 19/157,387

(22) PCT Filed: Feb. 23, 2024
(86) PCT No.: PCT/IB2024/051769

§ 371 Date: Aug. 18, 2025

Related U.S. Application Data
(60) Provisional application No. 63/451,791, filed on Mar. 13, 2023.

(51) Int. Cl. H01R 12/71; H01R 13/24; H01R 13/50; H01R 13/6585

(52) U.S. Cl. CPC H01R 12/716; H01R 13/2442; H01R 13/50; H01R 13/6585

(57) ABSTRACT

A number of board-to-board array connectors are described. An example connector includes a receptacle assembly and a plug assembly. The receptacle assembly includes a receptacle housing and a receptacle interface assembly. The plug assembly includes a plug housing and a plug interface assembly. The plug interface assembly includes a plug contact blade having a cantilevered blade beam. The cantilevered blade beam can be centrally positioned within the plug contact blade in one example. The cantilevered blade beam can be cantilevered toward a contact blade end of the cantilevered blade beam and extends toward a mount end of the cantilevered blade beam. The receptacle interface assembly includes a receptacle contact having a pair of contact beams. The cantilevered blade beam is configured to bend as the pair of contact beams electrically contact and slide along surfaces of the cantilevered blade beam.

### RELATED APPLICATION

The present application claims priority to U.S. Provisional Patent Application No. 63/451,791 filed on Mar. 13, 2023, which is incorporated by reference in its entirety.

### BACKGROUND

Connectors, connector assemblies, and housings for connectors are important structural and functional components in many computing and data interconnect systems. A number of different types and styles of connectors are known and used to electrically transfer data and radio frequency signals among interconnected boards and systems. Board-to-board connectors are relied upon to electrically couple data signals, radio frequency signals, and power between various types of printed circuit boards and other electrical and electro-mechanical assemblies. With the continued increase in the number of features and capabilities of electronics and related devices, such as cellular phones, computers, tablets, and other devices, many devices now include several printed circuits boards and related assemblies in a common housing.

### SUMMARY

A number of board-to-board array connectors are described. An example connector includes a receptacle assembly and a plug assembly. The receptacle assembly includes a receptacle housing and a receptacle interface assembly. The plug assembly includes a plug housing and a plug interface assembly. The plug interface assembly includes a plug contact blade having a cantilevered blade beam. The cantilevered blade beam can be centrally positioned within the plug contact blade in one example. The cantilevered blade beam can be cantilevered toward a contact blade end of the cantilevered blade beam and extends toward a mount end of the cantilevered blade beam. The receptacle interface assembly includes a receptacle contact having a pair of contact beams. The cantilevered blade beam is configured to bend as the pair of contact beams electrically contact and slide along surfaces of the cantilevered blade beam.

Another example connector includes a receptacle assembly. The receptacle assembly includes a receptacle housing and a receptacle interface assembly. The receptacle interface assembly includes a receptacle shield body having a compliant extension contact. The compliant extension contact includes a cantilevered shield arm. The cantilevered shield arm can be cantilevered toward a contact end of the receptacle shield body extends toward a mount end of the receptacle shield body. The cantilevered shield arm can include a compliant arm and a shield paddle. The shield paddle is separated from the receptacle shield body by a shield clearance area, and the shield paddle is configured to bend from a position further toward the center of the receptacle shield body to a position further away from the center of the receptacle shield body.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example board-to-board array connector according to various embodiments of the present disclosure.

FIG. 1B illustrates a first side view of the example board-to-board array connector shown in FIG. 1A according to various embodiments of the present disclosure.

FIG. 1C illustrates a second side view of the example board-to-board array connector shown in FIG. 1A according to various embodiments of the present disclosure.

FIG. 2A illustrates a perspective view of a receptacle assembly of the board-to-board array connector shown in FIG. 1A according to various embodiments of the present disclosure.

FIG. 2B illustrates a top-down view of the receptacle assembly of the board-to-board array connector shown in FIG. 1A according to various embodiments of the present disclosure.

FIG. 3A illustrates a perspective view of a plug assembly of the board-to-board array connector shown in FIG. 1A according to various embodiments of the present disclosure.

FIG. 3B illustrates a top-down view of the plug assembly of the board-to-board array connector shown in FIG. 1A according to various embodiments of the present disclosure.

FIG. 4A illustrates the cross-sectional view of the board-to-board array connector designated A-A in FIG. 1A according to various embodiments of the present disclosure, with the plug assembly separated from the receptacle assembly.

FIG. 4B illustrates the cross-sectional view of the board-to-board array connector designated A-A in FIG. 1A according to various embodiments of the present disclosure.

FIG. 5 illustrates plug interface assemblies and receptacle interface assemblies of the connector shown in FIG. 1A according to various embodiments of the present disclosure.

FIG. 6A illustrates a perspective view of a receptacle interface assembly of the connector shown in FIG. 1A according to various embodiments of the present disclosure.

FIG. 6B illustrates a contact end of the receptacle interface assembly shown in FIG. 6A according to various embodiments of the present disclosure.

FIG. 6C illustrates a mounting end of the receptacle interface assembly shown in FIG. 6A according to various embodiments of the present disclosure.

FIG. 6D illustrates the receptacle interface assembly shown in FIG. 6A, with the shield body omitted from view, according to various embodiments of the present disclosure.

FIG. 6E illustrates the receptacle interface assembly shown in FIG. 6A, with the shield body and receptacle contact insulator omitted from view, according to various embodiments of the present disclosure.

FIG. 7A illustrates a perspective view of a plug interface assembly of the connector shown in FIG. 1A according to various embodiments of the present disclosure.

FIG. 7B illustrates a contact end of the plug interface assembly shown in FIG. 7A according to various embodiments of the present disclosure.

FIG. 7C illustrates a mounting end of the plug interface assembly shown in FIG. 7A according to various embodiments of the present disclosure.

FIG. 7D illustrates the plug interface assembly shown in FIG. 7A, with the shield body omitted from view, according to various embodiments of the present disclosure.

FIG. 8 illustrates an example receptacle contact in the receptacle interface assembly shown in FIG. 6A according to various embodiments of the present disclosure.

FIG. 9 illustrates an example plug contact blade in the plug interface assembly shown in FIG. 7A according to various embodiments of the present disclosure.

FIG. 10 illustrates the receptacle contact shown in FIG. 8 and the plug contact blade shown in FIG. 9, in electrical contact with each other, according to various embodiments of the present disclosure.

FIG. 11 illustrates the cross-sectional view designated B-B in FIG. 5 according to various embodiments of the present disclosure.

FIG. 12A illustrates a perspective view of another example receptacle interface assembly that can be used in a board-to-board array connector according to various embodiments of the present disclosure.

FIG. 12B illustrates a side view of the receptacle interface assembly shown in FIG. 12A according to various embodiments of the present disclosure.

### DETAILED DESCRIPTION

Connectors, connector assemblies, and housings for connectors are important structural and functional components in many computing and data interconnect systems. A number of different types and styles of connectors are known and used to electrically transfer data and radio frequency (RF) signals among interconnected systems. Board-to-board connectors are relied upon to electrically couple data signals, RF signals, and power between various types of printed circuit boards (PCBs) and other electrical and electro-mechanical assemblies. With the continued miniaturization of electronics and related devices, such as cellular phones, computers, tablets, and other devices, engineers are working to package many different PCBs closely together in a common housing. One limitation for arranging PCBs into closer proximity with each other, however, is the size of the board-to-board and other connectors and contactors used to electrically communicate the data and RF signals among them.

In the context outlined above, a number of board-to-board array connectors are described. An example connector includes a receptacle assembly and a plug assembly. The receptacle assembly includes a receptacle housing and a receptacle interface assembly. The plug assembly includes a plug housing and a plug interface assembly. The plug interface assembly includes a plug contact blade having a cantilevered blade beam. The cantilevered blade beam can be centrally positioned within the plug contact blade in one example. The cantilevered blade beam can be cantilevered toward a contact blade end of the cantilevered blade beam and extends toward a mount end of the cantilevered blade beam. The receptacle interface assembly includes a receptacle contact having a pair of contact beams. The cantilevered blade beam is configured to bend as the pair of contact beams electrically contact and slide along surfaces of the cantilevered blade beam. Another example connector includes a receptacle assembly. The receptacle assembly includes a receptacle housing and a receptacle interface assembly. The receptacle interface assembly includes a receptacle shield body having a compliant extension contact. The compliant extension contact includes a cantilevered shield arm. The cantilevered shield arm can be cantilevered toward a contact end of the receptacle shield body extends toward a mount end of the receptacle shield body. The cantilevered shield arm can include a compliant arm and a shield paddle. The shield paddle is separated from the receptacle shield body by a shield clearance area, and the shield paddle is configured to bend from a position further toward the center of the receptacle shield body to a position further away from the center of the receptacle shield body.

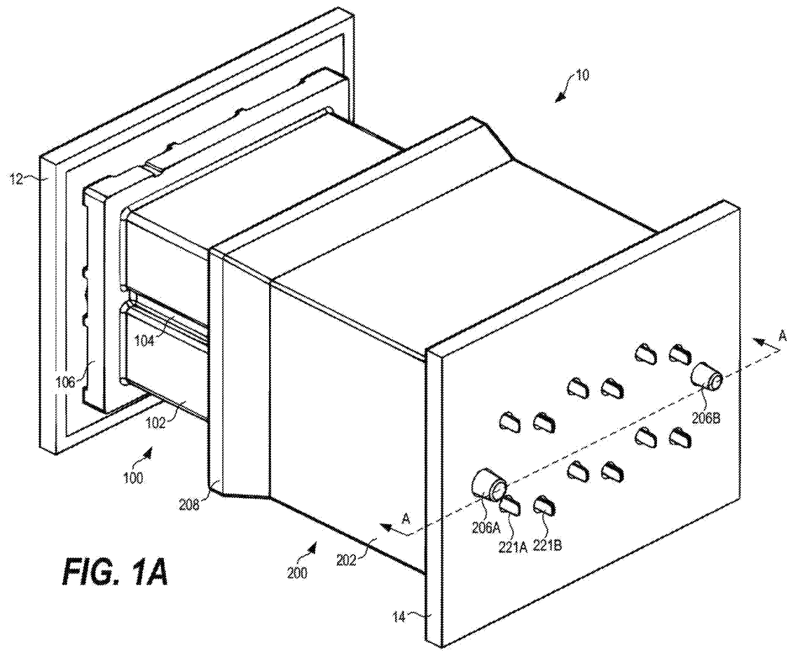

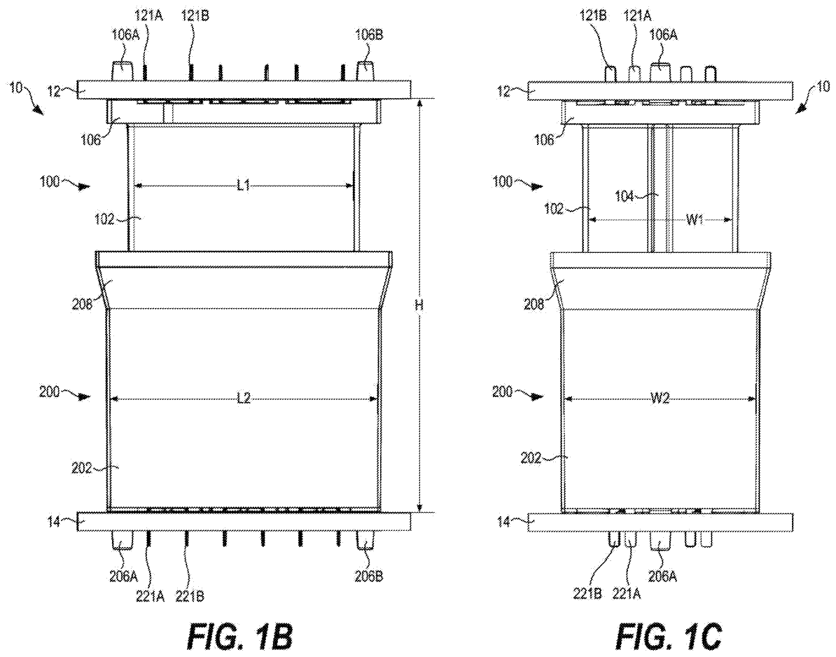

Turning to the drawings, FIG. 1A illustrates a perspective view of an example board-to-board array connector 10 (also “connector 10”) according to various embodiments of the present disclosure. FIG. 1B illustrates a first side view of the board-to-board array connector 10, and FIG. 1C illustrates a second side view of the board-to-board array connector 10. The connector 10 shown in FIGS. 1A-1C is representative, not drawn to any particular scale, and is illustrated to provide context for the concepts of the board-to-board array connectors described herein. The connectors described herein can be formed in a range of different shapes, styles, and sizes, although certain sizes and shapes are described and illustrated. The connectors described herein can be used in a range of interconnect applications, although board-to-board interface applications are described in some examples.

The connector 10 can be relied upon as a type of board-to-board connector for electrically coupling signals, including but not limited to RF signals, for example, between two different PCBs, as described herein. The connector 10 includes receptacle assembly 100 and a plug assembly 200. The connector 10 is positioned between two PCBs. Particularly, the receptacle assembly 100 is mechanically and electrically coupled to the PCB 12, and the plug assembly 200 is mechanically and electrically coupled to the PCB 14. Conductive signal paths and traces on the PCB 12, carrying RF signals, are electrically coupled through the connector 10 to conductive signal paths and traces on the PCB 14.

Among other components described below, the receptacle assembly 100 includes a housing 102. The housing 102 includes a keyway 104 formed in and extending along one side of the housing 102. The housing 102 also includes a housing base 106, which is seated upon a surface of the PCB 12 in the example shown. The housing 102 can be formed as an integral part or piece in one example, although the housing 102 can also be formed from two or more separate parts or pieces in some cases. The housing 102 can be formed from an insulating material, such as a plastic or polymer, a thermoplastic resin, a liquid crystal polymer (LCP), a glass fiber epoxy compound, Polytetrafluoroethylene (PTFE), polyimide, or other insulating material(s). The housing 102 can be plated with a conductive plating material in some examples. Thus, the housing 102 can be embodied as a plated plastic in some cases.

The plug assembly 200 includes a housing 202. The housing 202 also includes a mating bonnet 208 at one end, and the housing 102 of the receptacle assembly 100 can be inserted into the plug assembly 200 using the mating bonnet 208 to guide the alignment of the receptacle assembly 100 with the plug assembly 200. One end of the housing 202 is seated upon a surface of the PCB 14 in the example shown. The housing 202 can be formed as an integral part or piece in one example, although the housing 202 can also be formed from two or more separate parts or pieces in some cases. The housing 202 can be formed from an insulating material, such as a plastic or polymer, a thermoplastic resin, a liquid crystal polymer (LCP), a glass fiber epoxy compound, Polytetrafluoroethylene (PTFE), polyimide, or other insulating material(s). The housing 202 can be plated with a conductive plating material in some examples. Thus, the housing 202 can be embodied as a plated plastic in some cases.

Referring to FIGS. 1B and 1C, the housing 102 includes positioning posts 106A and 106B, which extend off the housing base 106. The positioning posts 106A and 106B extend through apertures in the PCB 12, to align the housing 102 with conductive pads, traces, or other features on the PCB 12. In other examples, the positions or locations of the positioning posts 106A and 106B can vary as compared to that shown, the housing 102 can include additional positioning posts at other positions, or one or both of the positioning posts 106A and 106B can be omitted. Additionally, the positioning posts 106A and 106B can vary in size (e.g., in diameter, length, width, etc.), in shape (e.g., circular, oval, square, rectangular, etc.), or in both size and shape as compared to each other in some cases. Such variations among the positioning posts 106A and 106B can provide a type of polarizing or orienting mechanism, to ensure the intended orientation of the housing 102 with respect to the PCB 12.

The housing 102 also includes ground legs 121A and 121B, among others. The ground legs 121A and 121B extend from shield bodies positioned within the housing 102, as described below. The ground legs 121A and 121B extend through apertures or vias in the PCB 12. The ground legs 121A and 121B can be press-or interference-fit through the apertures, in one example, or the ground legs 121A and 121B can extend through the apertures with a clearance. The apertures through the PCB 12 for the ground legs 121A and 121B can also be plated in some cases, such as plated vias in one example, and the ground legs 121A and 121B can be soldered or otherwise electrically connected to the plated vias or other conductive traces on the PCB 12.

The housing 202 includes positioning posts 206A and 206B, which extend off the housing 202. The positioning posts 206A and 206B extend through apertures in the PCB 14, to align the housing 202 with conductive pads, traces, or other features on the PCB 14. In other examples, the positions or locations of the positioning posts 206A and 206B can vary as compared to that shown, the housing 202 can include additional positioning posts at other positions, or one or both of the positioning posts 206A and 206B can be omitted. Additionally, the positioning posts 206A and 206B can vary in size (e.g., in diameter, length, width, etc.), in shape (e.g., circular, oval, square, rectangular, etc.), or in both size and shape as compared to each other in some cases. Such variations among the positioning posts 206A and 206B can provide a type of polarizing or orienting mechanism, to ensure the intended orientation of the housing 202 with respect to the PCB 14.

The plug assembly 200 also includes ground legs 221A and 221B, among others. The ground legs 221A and 221B extend from shield bodies positioned within the housing 202, as described below. The ground legs 221 A and 221B extend through apertures or vias in the PCB 14. The ground legs 221A and 221B can be press-or interference-fit through the apertures, in one example, or the ground legs 221A and 221B can extend through the apertures with a clearance. The apertures through the PCB 14 for the ground legs 221 A and 221B can be plated, such as plated vias in one example, and the ground legs 221A and 221B can be soldered or otherwise electrically connected to the plated vias or other conductive traces on the PCB 14.

When interfaced with each other between the PCBs 12 and 14, the connector 10 has a total height “H” between the PCBs 12 and 14, as shown in FIGS. 1B and 1C. The receptacle assembly 100 has a length “L1” and a width “W1.” The plug assembly 200 has a length “L2” and a width “W2.” The “L1” and “W1” dimensions of the receptacle assembly 100 are smaller than the “L2” and “W2” dimensions of the plug assembly 200, so that the receptacle assembly 100 can fit and be inserted within the plug assembly 200, as also described below. The connector 10 can be manufactured to a range of sizes. Example dimensions of “H” can range from 10-40 mm, but the connector 10 can be formed to larger or smaller sizes in some cases. Thus, the connector 10 can be tailored to accommodate a range of board-to-board spacings between PCBs. Example dimensions of “L1” and “W1” can range from 10-20 mm, from 10-30 mm, from 10-40 mm, from 10-50 mm, or larger ranges. Similarly, example dimensions of “L2” and “W2” can range from 10-20 mm, from 10-30 mm, from 10-40 mm, from 10-50 mm, or larger ranges. Overall, the “L1,” “L2,” “W1,” and “W2” dimensions can vary depending on the number of RF signals being passed through the connector 10. The connector 10 is designed to electrically couple six (6) different RF signals, with sufficient electromagnetic isolation between, but other connectors can be designed to couple eight, ten, twelve, or more RF signals. The shape and size of the connector 10 can thus range depending on the design needs for a particular application.

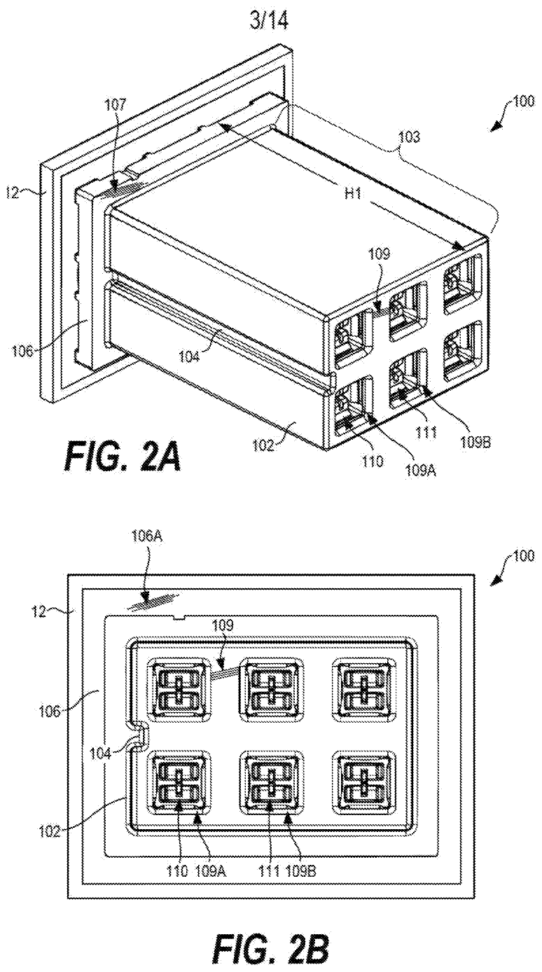

FIG. 2A illustrates a perspective view of the receptacle assembly 100 of the connector 10 shown in FIGS. 1A-1C. FIG. 2B illustrates a top-down view of the receptacle assembly 100. The plug assembly 200 is omitted from view in FIGS. 2A and 2B. The housing 102 of the receptacle assembly 100 includes a receptacle body 103 and the housing base 106. The receptacle body 103 extends from the top surface 107 of the housing base 106 to the end surface 109 of the housing 102. The receptacle assembly 100 can be inserted into the plug assembly 200, with the end surface 109 of the housing 102 being inserted into the plug assembly 200 first. The dimension of “H1” of the housing 102 can range, depending on the overall design and height “H” for the connector 10 (see FIGS. 1B and 1C).

The keyway 104 is formed in and extends along one side of the receptacle body 103. The housing 102 includes one keyway 104 in the example shown, but the housing 102 can include other keyways at other positions. Overall, the number and positions of any keyways of the housing 102 can vary among the embodiments. The keyway 104 polarizes or orients the housing 102 with the housing 202 of the plug assembly 200, to ensure the correct mechanical and electrical coupling between them when they are connected or assembled with each other.

A number of openings, including the openings 109A and 109B, among others, are formed in the end surface 109 of the housing 102. The openings 109A and 109B extend through the housing 102, from the end surface 109 of the housing 102 to and through the housing base 106. A receptacle interface assembly is positioned within each of the openings. Example receptacle interface assemblies 110 and 111 are identified in FIGS. 2A and 2B, positioned respectively within the openings 109A and 109B. The receptacle interface assemblies 110 and 111, among others, are described in further detail below. The receptacle interface assemblies 110 and 111 are oriented the same way as each other in the example shown, as are the receptacle interface assemblies in the other openings of the housing 102. However, one or both of the receptacle interface assemblies 110 and 111, among others, can be rotated (e.g., by 90°) as compared to that shown, and the receptacle assembly 100 can include a mixture of receptacle interface assemblies having different orientations. The receptacle assembly 100 includes a total of six (6) openings in the end surface 109 of the housing 102 in the example shown, but other connectors with receptacle assemblies having more or less than six openings are within the scope of the embodiments.

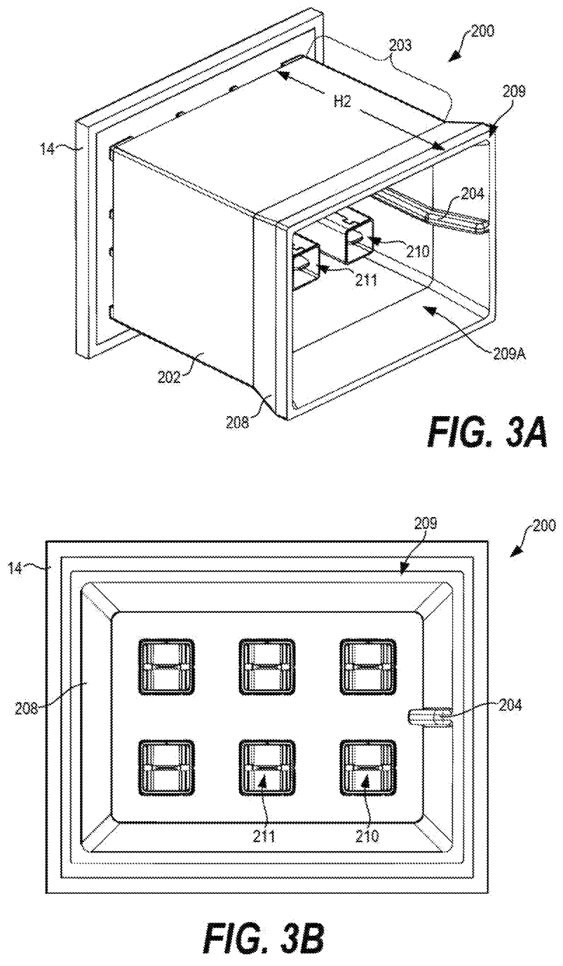

FIG. 3A illustrates a perspective view of the plug assembly 200 of the connector 10 shown in FIGS. 1A-1C. FIG. 3B illustrates a top-down view of the plug assembly 200. The receptacle assembly 100 is omitted from view in FIGS. 3A and 3B. The housing 202 of the plug assembly 200 includes a plug body 203 and the mating bonnet 208. The plug body 203 extends from one end of the housing 202 to the mating bonnet 208. The mating bonnet 208 is outwardly tapered away from outer surfaces of the plug body 203, until reaching the end surface 209 of the housing 202. The dimension “H2” of the housing 202 can range, depending on the overall design and height “H” for the connector 10 (see FIGS. 1B and 1C).

The housing 202 includes a central opening or cavity 209A. The cavity 209A is sized to permit insertion of the receptacle body 103 of the housing 102 (see FIG. 2) within the cavity 209A, with a nominal clearance for movement between them. The receptacle body 103 of the housing 102 can be inserted to a varying extent (i.e., to a varying distance) into the cavity 209A of the housing 202. Receptacle contacts of the receptacle assembly 100 can make electrical contact with plug contact blades of the plug assembly 200 over a range of insertion, when the receptacle assembly 100 is inserted into the plug assembly 200, as described below. Thus, the connector 10 can facilitate a range of dimensions or spacings between PCBs, such as the PCBs 12 and 14, to account for design tolerances, manufacturing tolerances, and other considerations.

A plug ridge 204 extends along an inner surface within the housing 202, as shown in FIGS. 3A and 3B. The housing 202 includes one plug ridge 204 in the example shown, but the housing 202 can include other ridges at other positions. Overall, the number and positions of any ridges of the housing 202 can vary among the embodiments. The plug ridge 204 polarizes or orients the housing 202 of the plug assembly 200 with the housing 102 of the receptacle assembly 100, to ensure the correct mechanical and electrical coupling between them when they are connected together. Particularly, the plug ridge 204 of the housing 202 is designed and sized to slide within the keyway 104 of the housing 102 when they are connected or assembled with each other.

The plug assembly 200 also includes a number of plug interface assemblies, such as the plug interface assemblies 210 and 211, among others, as shown in FIGS. 3A and 3B. The plug interface assemblies 210 and 211 are oriented the same way as each other in the plug assembly 200 shown, as are the other plug interface assemblies. However, one or both of the plug interface assemblies 210 and 211, among others, can be rotated (e.g., by 90°) as compared to that shown, and the plug assembly 200 can include a mixture of plug interface assemblies having different orientations. In any case, among the receptacle assembly 100 and the plug assembly 200, the receptacle interface assemblies and the corresponding plug interface assemblies can be oriented with respect to each other so that the receptacle contacts in the receptacle interface assemblies are oriented for insertion into the plug contact blades in the plug interface assemblies.

When the receptacle assembly 100 is inserted into the plug assembly 200, the plug interface assemblies 210 and 211 of the plug assembly 200 extend into the openings 109A and 109B of the receptacle assembly 100. The plug interface assemblies 210 and 211 engage and contact with the receptacle interface assemblies 110 and 111, respectively, when the receptacle assembly 100 is inserted into the plug assembly 200. One RF signal is electrically coupled between the PCBs 12 and 14 via the connector 10, through the plug interface assembly 210 and the receptacle interface assembly 110. Another RF signal is electrically coupled between the PCBs 12 and 14 via the connector 10, through the plug interface assembly 211 and the receptacle interface assembly 111. Other RF signals are also coupled between the PCBs 12 and 14 through other interface assemblies of the connector 10 as described herein.

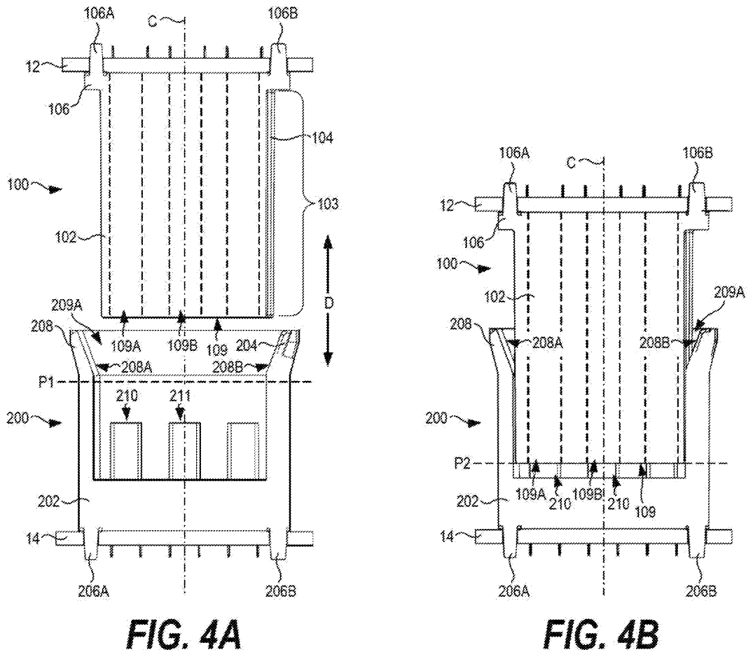

FIG. 4A illustrates the cross-sectional view of the connector 10 designated A-A in FIG. 1A, with the receptacle assembly 100 separated from the receptacle assembly 200. As shown, the receptacle assembly 100 can be positioned and centered with the plug assembly 200, and the receptacle body 103 of the receptacle assembly 100 can be inserted into the cavity 209A of the receptacle assembly 100 by movement of the receptacle assembly 100 generally in the direction “D”. Alternatively, the receptacle assembly 100 can be positioned and centered with the plug assembly 200, and the central cavity 209A of the plug assembly 200 can be fitted over the receptacle body 103 by movement of the of the plug assembly 200 generally in the direction “D”. The receptacle assembly 100 and the plug assembly 200 can also be positioned and moved, respectively, in some cases, to connect them together.

It is not necessary that the receptacle assembly 100 and the plug assembly 200 be perfectly centered or aligned with each other before the mating or connecting process proceeds. The mating bonnet 208 includes tapered internal surfaces, such as the tapered surfaces 208A and 208B, among others. Thus, even if the receptacle assembly 100 and the plug assembly 200 are not perfectly aligned with each other along the centerline “C,” the tapered surfaces 208A and 208B will help to channel or funnel the receptacle body 103 of the housing 102 into the cavity 209A of the housing 202. The keyway 104 of the housing 102 will also interface with the plug ridge 204 of the housing 202 during the mating or connecting process to ensure the correct orientation of the receptacle assembly 100 with respect to the plug assembly 200.

As the receptacle assembly 100 and the plug assembly 200 are mated, the end surface 109 of the housing 102 will be directed towards the center of the cavity 209A as it approaches the insertion point “P1.” The insertion of the receptacle body 103 of the housing 102 to the point “P1” completes a first or primary phase of alignment of the receptacle assembly 100 with the plug assembly 200. At that point (i.e., when the end surface 109 of the housing 102 reaches the point “P1” within the cavity 209A of the housing 202), the plug interface assemblies 210 and 211 of the receptacle assembly 200, among others, still have not been inserted into (and do not extend into) the openings 109A and 109B, among others, in the housing 102. The connector 10 includes additional features that help to further align the plug interface assemblies of the receptacle assembly 200 with the receptacle interface assemblies of the plug assembly 100, as described below.

FIG. 4B illustrates the cross-sectional view designated A-A in FIG. 1A, with the receptacle assembly 100 inserted into the plug assembly 200 to the same extent as that shown in FIG. 1A. As shown in FIG. 4B, the end surface 109 of the housing 102 has been inserted into and reached the point “P2” within the cavity 209A of the housing 202. The plug interface assemblies 210 and 211 of the plug assembly 200, among others, have also been inserted into (and extend into) the openings 109A and 109B, among others, in the housing 102 of the receptacle assembly 100 in FIG. 4B. Thus, the plug interface assemblies 210 and 211 of the plug assembly 200 have also mated and made electrical contact with the receptacle interface assemblies 110 and 111 (see FIGS. 2A and 2B), which are positioned within the openings 109A and 109B in the receptacle assembly 100. It is not necessary that the end surface 109 of the housing 102 reach the point “P2,” however, before electrical contact occurs between the plug interface assemblies and the receptacle interface assemblies of the receptacle assembly 100 and the plug assembly 200. Electrical contact between them occurs over a range of insertion, before the end surface 109 of the housing 102 reach the point “P2,” as described below.

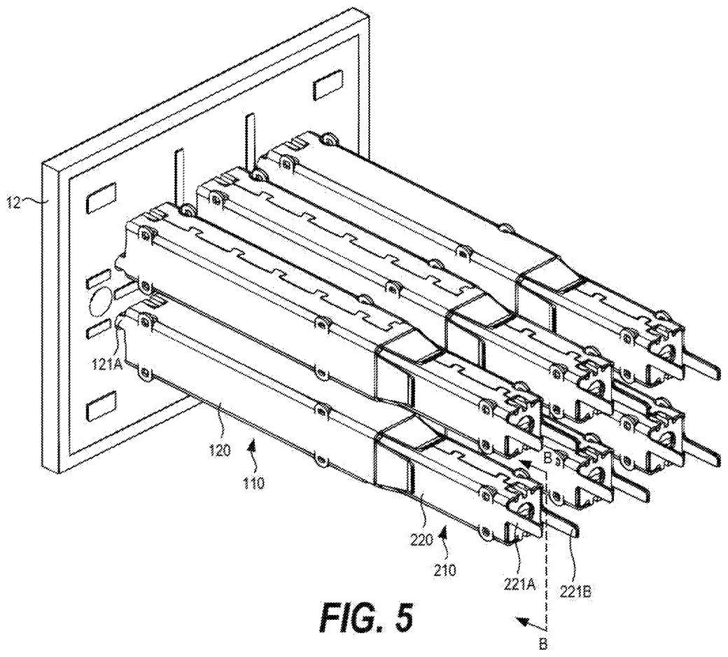

FIG. 5 illustrates the plug interface assemblies and the receptacle interface assemblies of the connector 10 shown in FIG. 1A. The housings 102 and 202 of the connector 10 are omitted from view in FIG. 5, as is the PCB 14, so that the interface assemblies are visible. Six plug and receptacle interface assemblies are shown in FIG. 5. Among others, the receptacle interface assembly 110 and the plug interface assembly 210 are shown and separately referenced in FIG. 5, and additional interface assemblies are also illustrated (but not separately referenced).

The receptacle interface assembly 110 includes a receptacle shield body 120. The plug interface assembly 210 includes a plug shield body 220. The other receptacle and plug interface assemblies each include identical or similar shield bodies. In the configuration shown, the plug shield body 220 has been inserted into and makes electrical contact with the receptacle shield body 120. The plug shield body 220 includes the ground legs 221 A and 221B, and the receptacle shield body 120 includes the ground legs 121A and 121B (see also FIGS. 1B and 1C). The shield bodies 120 and 220 can be formed from an electrically-conductive, metallic material, such as aluminum, copper, or other conductive metals or alloys thereof. In one example, the shield bodies 120 and 220 can be stamped or sheared out from a sheet of the electrically-conductive, metallic material, and then be bent or otherwise formed into the shapes shown in FIG. 5, although the shield bodies 120 and 220 can also be formed in other suitable ways.

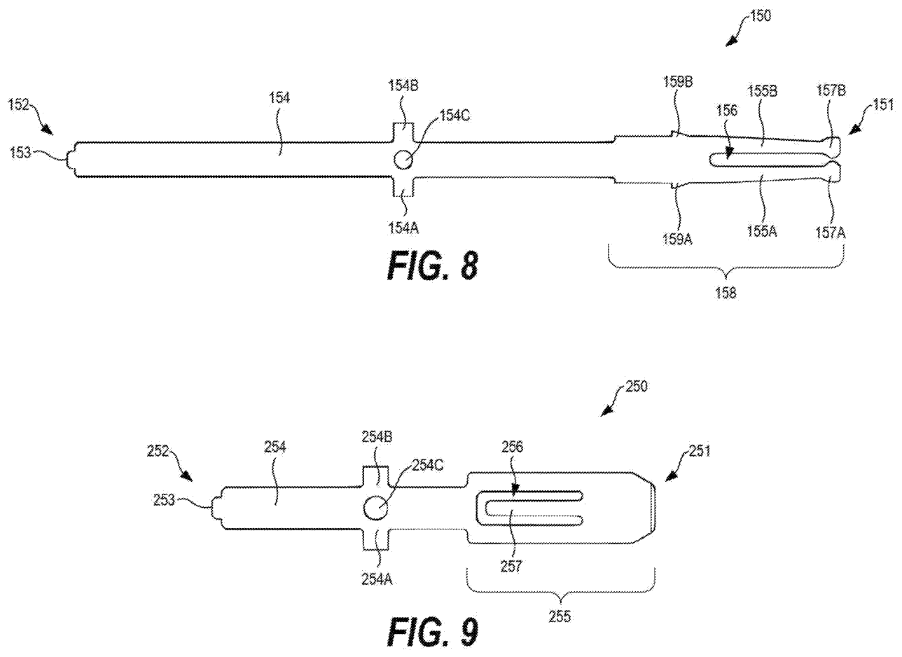

A receptacle contact 150 (see FIG. 8), including contact beams, extends within the receptacle interface assembly 110. A plug contact blade 250 (see FIG. 9), including a cantilevered blade beam, extends within the plug interface assembly 210. The receptacle contact 150 is electrically insulated from the receptacle shield body 120, and the plug contact blade 250 is electrically insulated from the plug shield body 220. However, the receptacle contact 150 makes electrical contact with the plug contact blade 250 inside the shield bodies 120 and 220, as also described below. The receptacle contact 150 and the plug contact blade 250 provide an electrical pathway for an RF signal, and the shield bodies 120 and 220 provide an electrical shield (e.g., an electromagnetic interference (EMI) shield) for the RF signal.

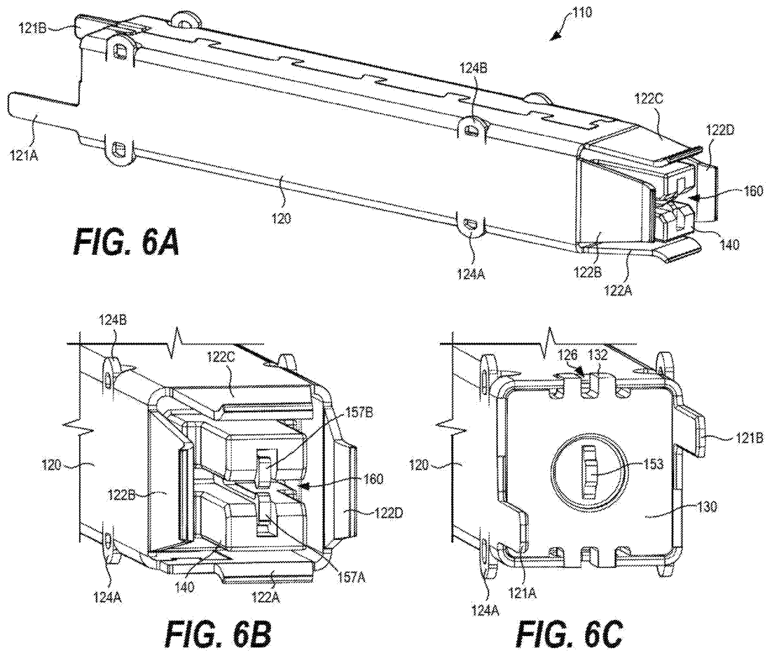

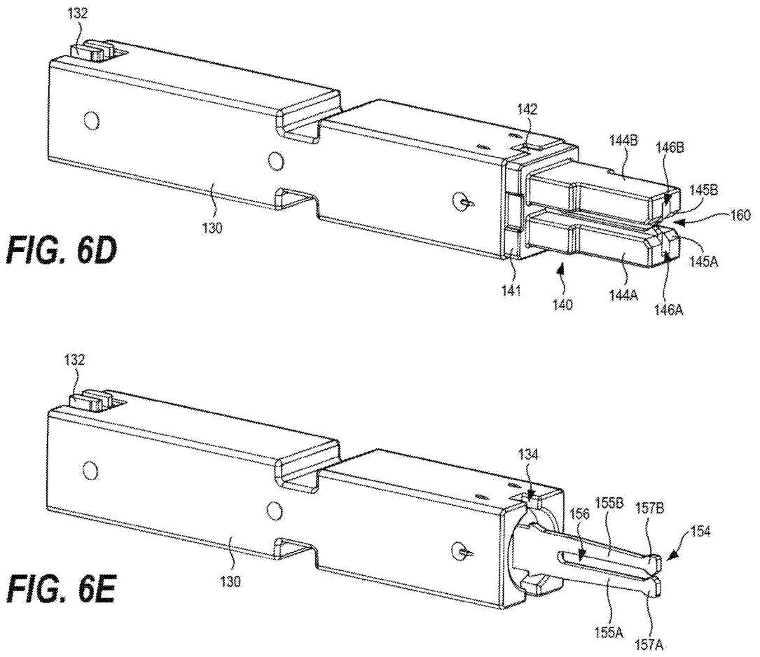

FIG. 6A illustrates the receptacle interface assembly 110 of the connector 10 shown in FIG. 1A. FIG. 6B illustrates a contact end of the receptacle interface assembly 110 shown in FIG. 6A, and FIG. 6C illustrates a mounting end of the receptacle interface assembly 110 shown in FIG. 6A. The components shown in FIGS. 6A-6C are representative, not drawn to any particular scale, and are illustrated to provide context for the concepts of the board-to-board array connectors described herein. The components can be formed in a range of different shapes, styles, and sizes, although certain sizes and shapes are described and illustrated.

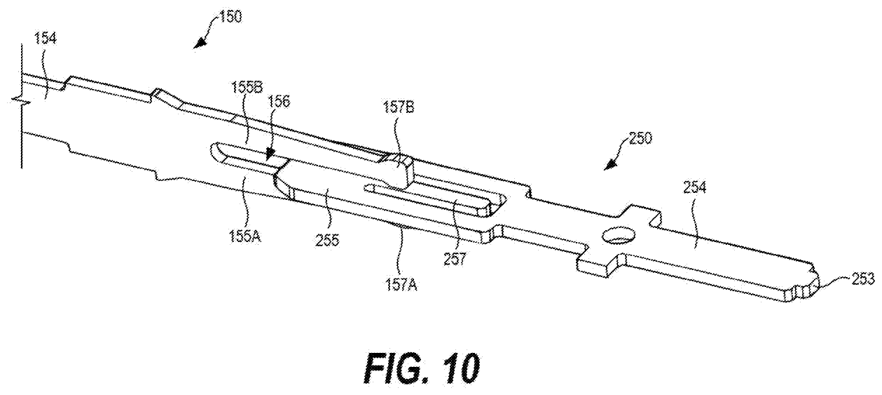

Referring among FIGS. 6A-6C, the receptacle interface assembly 110 includes the receptacle shield body 120, a receptacle body insulator 130 (see FIG. 6D), a receptacle contact insulator 140, and a receptacle contact 150 (see also FIG. 8). The receptacle body insulator 130 and receptacle contact insulator 140 are described in further detail below with reference to FIG. 6D, and the receptacle contact 150 is described in further detail below with reference to FIGS. 8 and 10.

The receptacle shield body 120 can be formed from an electrically-conductive, metallic material, such as aluminum, copper, or other conductive metals or alloys thereof. In one example, the receptacle shield body 120 can be stamped or sheared out from a sheet of the electrically-conductive, metallic material, and then be bent or otherwise formed into the shape shown in FIGS. 6A-6C. The receptacle shield body 120 is generally formed as a hollow, rectangular cuboid, with rounded corners. The receptacle shield body 120 includes a number of housing detents, such as the detents 124A and 124B. The number and positions of the detents are illustrated as a representative example in FIGS. 6A-6C. In other cases, the number and positions of the detents can vary as compared to that shown. Additionally, the size, shape, and form of the detents can vary. For example, the detents can be shaped as teeth, posts, pins, or other types of projections. The detents can be relied upon to secure the receptacle interface assembly 110, among others, within the housing 102 of the receptacle assembly 100. Thus, the receptacle interface assembly 110, among others, can be inserted and secured within the housing 102 using a mechanical interference, friction-based, or related type of fit or interface. The detents can also be relied upon to help secure the receptacle body insulator 130 within the receptacle shield body 120 in some cases.

The receptacle shield body 120 includes the ground legs 121A and 121B at the mounting end shown in FIG. 6C. The ground legs 121A and 121B are illustrated as examples. In other cases, the receptacle shield body 120 can include additional or fewer ground legs than that shown in FIGS. 6A and 6C. The positions of the ground legs can also be varied as compared to that shown. The receptacle shield body 120 also includes a number of compliant extension contacts 122A-122D at a contact end shown in FIG. 6B. Each of the compliant extension contacts 122A-122D extends from one side surface of the receptacle shield body 120.

The plug shield body 220 of the plug interface assembly 210 (see FIG. 5) can be inserted into the receptacle shield body 120 at the contact end, and the inner surfaces of the compliant extension contacts 122A-122D will contact the outer surfaces of the plug shield body 220, making an electrical contact between them. The compliant extension contacts 122A-122D bend outwardly at the leading contact end and can help to align the plug shield body 220 with the receptacle shield body 120, as the plug shield body 220 is inserted into the receptacle shield body 120. For example, if the plug shield body 220 is offset or off-center (e.g., in the range of tenths or hundredths of a millimeter) with the receptacle shield body 120, the compliant extension contacts 122A-122D are designed to contact and apply centering forces to the plug shield body 220 as it is inserted into the receptacle shield body 120. The shield bodies 120 and 220 provide an EMI shield for the RF signal carried on the receptacle contact 150.

Referring to FIG. 6B, the receptacle contact 150 includes contact circlets 157A and 157B positioned, respectively, at the distal ends of contact beams 155A and 155B (see FIG. 8) of the receptacle contact 150. The contact circlets 157A and 157B are separated, with a clearance between them, and are positioned within channels formed in the receptacle contact insulator 140. A contact channel 160 (see also FIG. 6A) extends between the contact circlets 157A and 157B, the contact beams 155A and 155B, and within the receptacle contact insulator 140. A plug contact blade 250 (see FIG. 9) of the plug interface assembly 210 can be inserted into the contact channel 160. An electrical contact can be formed between the receptacle contact 150 and the plug contact blade 250 within the contact channel 160, as described in further detail below. As noted above, the compliant extension contacts 122A-122D bend outwardly and can help with alignment of the plug shield body 220 into the receptacle shield body 120. Thus, the compliant extension contacts 122A-122D can also help with alignment of the plug contact blade 250 into the contact channel 160 and between the contact beams 155A and 155B of the receptacle contact 150.

The receptacle body insulator 130 can be formed from an insulating material, such as a plastic or polymer, a thermoplastic resin, LCP, a glass fiber epoxy compound, PTFE, polyimide, or other insulating material(s). The receptacle body insulator 130 electrically insulates and isolates the receptacle contact 150 from the receptacle shield body 120. The receptacle body insulator 130 can be molded (e.g., injection molded, over-molded, etc.) around the receptacle contact 150, at least in part, in one example. More particularly, the receptacle body insulator 130 can be molded around the receptacle contact 150, with the contact beams 155A and 155B (or at least some portion thereof) being exposed and extending out from the contact end of the receptacle body insulator 130, as also described below with reference to FIG. 6E. A mount contact 153 of the receptacle contact 150 can also be exposed and extend out from the mounting end of the receptacle body insulator 130, as shown in FIG. 6C. After the receptacle body insulator 130 is molded around the receptacle contact 150, the molding assembly can be sheared out from a larger lead frame including the receptacle contact 150, among others.

The receptacle contact insulator 140 can be separately formed from an insulating material, such as a plastic or polymer, a thermoplastic resin, LCP, a glass fiber epoxy compound, PTFE, polyimide, or other insulating material(s). The receptacle contact insulator 140 can be placed over the contact beams 155A and 155B of the receptacle contact 150. This assembly, which is shown in FIG. 6D, can be inserted and fitted within the receptacle shield body 120. In other cases, rather than the receptacle contact insulator 140 being formed separately from the receptacle body insulator 130, the receptacle body insulator 130 and the receptacle contact insulator 140 can be integrally formed, as one molded piece.

Referring to FIG. 6C, the mount contact 153 of the receptacle contact 150 is exposed and extends out from the mounting end of the receptacle interface assembly 110. When the receptacle interface assembly 110 is mounted to the PCB 12, the mount contact 153 can be electrically contacted and connected (e.g., soldered, welded, etc.) to a conductive trace or pad on the PCB 12. The mount contact 153 is tailored for a surface mount connection, but the connector concepts described herein are not limited to surface mount contacts or couplings. The receptacle contact 150 can include a through-mount contact in place of the mount contact 153 in other cases. The ground legs 121A and 121B extend through apertures or vias in the PCB 12. The ground legs 121A and 121B can be press-or interference-fit through the apertures, in one example, or the ground legs 121A and 121B can extend through the apertures with a clearance. The apertures through the PCB 12 for the ground legs 121A and 121B can be plated, such as plated vias in one example, and the ground legs 121A and 121B can be soldered or otherwise electrically connected to the plated vias or other conductive traces on the PCB 12.

FIG. 6D illustrates the receptacle interface assembly 110 shown in FIG. 6A, with the shield body 120 omitted from view. FIG. 6E illustrates the receptacle interface assembly 110 shown in FIG. 6A, with the shield body 120 and the receptacle contact insulator 140 omitted from view. As noted above, the receptacle body insulator 130 can be formed from an insulating material and electrically isolates the receptacle contact 150 from the receptacle shield body 120. The receptacle body insulator 130 also mechanically supports and centrally positions the receptacle contact 150 within the receptacle shield body 120. As best shown in FIG. 6E, the receptacle body insulator 130 can be molded around the receptacle contact 150, with the contact beams 155A and 155B of the receptacle contact 150 being exposed and extending out from the contact end of the receptacle body insulator 130. After the receptacle body insulator 130 is molded around the receptacle contact 150, the receptacle contact 150 and receptacle body insulator 130 can be sheared out from a larger lead frame including the receptacle contact 150, among others.

The receptacle contact insulator 140 can be separately formed from an insulating material. The receptacle contact insulator 140 includes a base 141, one or more positioning joints, including the joint 142, that extend off the back of the base 141, and beam covers 144A and 144B. A contact beam channel 146A is formed in the beam cover 144A to provide a clearance for the contact beam 155A to extend within the receptacle contact insulator 140. Similarly, a contact beam channel 146B is formed in the beam cover 144B to provide a clearance for the contact beam 155B to extend within the receptacle contact insulator 140. The beam cover 144A includes a chamfered or tapered corner 145A at the contact end of the beam cover 144A, and the beam cover 144B includes a chamfered or tapered corner 145B at the contact end of the beam cover 144B. The tapered corners 145A and 145B help to channel or divert the plug contact blade 250 into the contact channel 160 and between the contact beams 155A and 155B of the receptacle contact 150.

The receptacle contact insulator 140 is separately formed and fitted over the contact beams 155A and 155B of the receptacle contact 150 to arrive at the assembly shown in FIG. 6D. The joint 142 of the receptacle contact insulator 140, for example, can be positioned into a notch 134 formed in the receptacle body insulator 130 to help position them with respect to each other. The assembly shown in FIG. 6D can then be inserted and fitted within the receptacle shield body 120. The receptacle body insulator 130 can also include a number of positioning extensions, one of which is referenced as the positioning extension 132 in FIGS. 6D and 6E. The positioning extensions can be fitted into body notches formed in the mounting end of the receptacle shield body 120. An example body notch 126 of the receptacle shield body 120 is illustrated in FIG. 6C, with the positioning extension 132 seated in the body notch 126. That and other mechanical interferences or mating features can be relied upon to secure the receptacle body insulator 130, the receptacle contact insulator 140, and the receptacle contact 150 into the receptacle shield body 120.

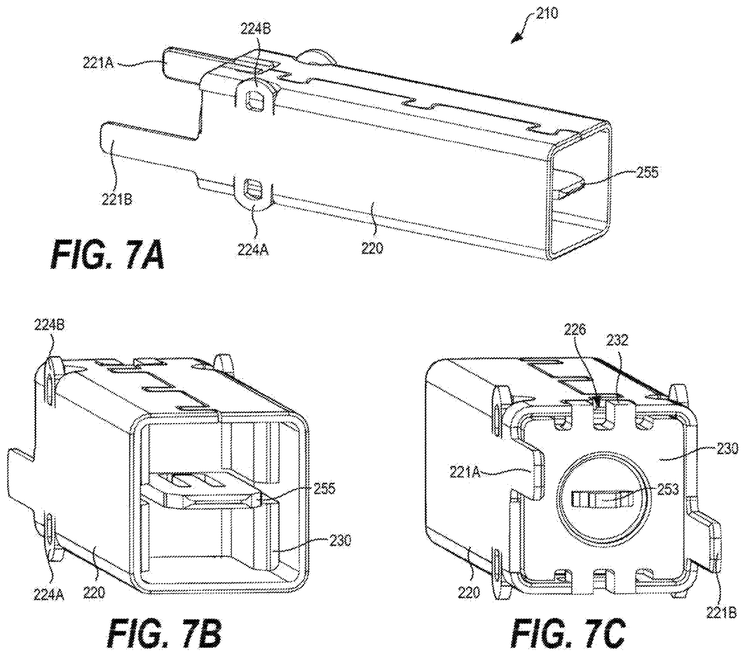

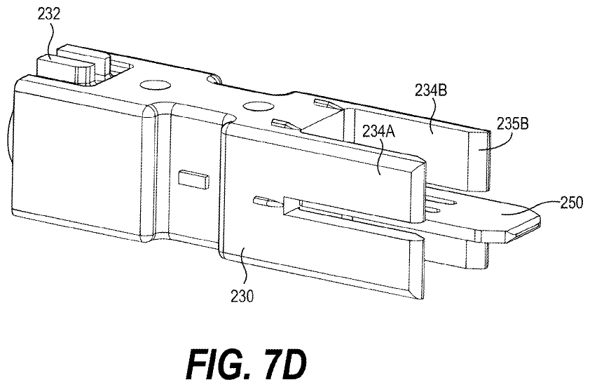

FIG. 7A illustrates the plug interface assembly 210 of the connector 10 shown in FIG. 1A. FIG. 7B illustrates a contact end of the plug interface assembly 210 shown in FIG. 7A, and FIG. 7C illustrates a mounting end of the plug interface assembly 210 shown in FIG. 7A. The components shown in FIGS. 7A-7C are representative, not drawn to any particular scale, and are illustrated to provide context for the concepts of the board-to-board array connectors described herein. The components can be formed in a range of different shapes, styles, and sizes, although certain sizes and shapes are described and illustrated. Referring among FIGS. 7A-7C, the plug interface assembly 210 includes the plug shield body 220, a plug body insulator 230 (see FIG. 7D), and a plug contact blade 250 (see also FIG. 9). The plug body insulator 230 is described in further detail below with reference to FIG. 7D, and the plug contact blade 250 is described in further detail below with reference to FIGS. 9 and 10.

The plug shield body 220 can be formed from an electrically-conductive, metallic material, such as aluminum, copper, or other conductive metals or alloys thereof. In one example, the plug shield body 220 can be stamped or sheared out from a sheet of the electrically-conductive, metallic material, and then be bent or otherwise formed into the shape shown in FIGS. 7A-7C. The plug shield body 220 is generally formed as a hollow, rectangular cuboid, with rounded corners. The plug shield body 220 includes a number of housing detents, such as the detents 224A and 224B. The number and positions of the detents are illustrated as a representative example in FIGS. 7A-7C. In other cases, the number and positions of the detents can vary as compared to that shown. Additionally, the size, shape, and form of the detents can vary. For example, the detents can be shaped as teeth, posts, pins, or other types of projections. The detents can be relied upon to secure the plug interface assembly 210, among others, within the housing 202 of the plug assembly 200. Thus, the plug interface assembly 210, among others, can be inserted and secured within the housing 202 using a mechanical interference, friction-based, or related type of fit or interface.

The plug shield body 220 includes the ground legs 221A and 221B at the mounting end shown in FIG. 7C. The ground legs 221 A and 221B are illustrated as examples. In other cases, the plug shield body 220 can include additional or fewer ground legs than that shown in FIGS. 7A and 7C. The positions of the ground legs can also be varied as compared to that shown. The contact end of the plug shield body 220 (see FIG. 7B) can be inserted into the contact end of the receptacle shield body 120 (see FIG. 6B). In that arrangement, the outer surfaces of the plug shield body 220 can contact the inner surfaces of the compliant extension contacts 122A-122D of the receptacle shield body 120, making an electrical contact between them. The shield bodies 120 and 220 provide an EMI shield for the RF signal carried on the receptacle contact 150 and the plug contact blade 250.

Referring to FIG. 7B, the blade end 255 of the plug contact blade 250 is positioned within the plug shield body 220, with the plug shield body 220 extending around it. The front edge of the blade end 255 can be recessed within the plug shield body 220 in some cases. When the contact end of the plug shield body 220 (see FIG. 7B) is inserted into the contact end of the receptacle shield body 120 (see FIG. 6B), the blade end 255 of the plug contact blade 250 can be inserted into the contact channel 160. The blade end 255 will then extend between the contact circlets 157A and 157B and the contact beams 155A and 155B of the receptacle contact 150, as also shown in FIG. 10. The circlets 157A and 157B will contact opposing side surfaces of the plug contact blade 250. An electrical contact will thus be formed between the receptacle contact 150 and the plug contact blade 250 within the contact channel 160, as described in further detail below with reference to FIG. 10.

Referring to FIG. 7C, the mount contact 253 of the plug contact blade 250 is exposed and extends out from the mounting end of the plug interface assembly 210. When the plug interface assembly 210 is mounted to the PCB 14, the mount contact 253 can be electrically contacted and connected (e.g., soldered, welded, etc.) to a conductive trace or pad on the PCB 14. The connector concepts described herein are not limited to surface mount contacts or couplings, however, and the plug contact blade 250 can include a through-mount contact in place of the mount contact 253 in other cases. The ground legs 221A and 221B extend through apertures or vias in the PCB 14. The ground legs 221 A and 221B can be press-or interference-fit through the apertures, in one example, or the ground legs 221A and 221B can extend through the apertures with a clearance. The apertures through the PCB 14 for the ground legs 221A and 221B can also be plated in some cases, such as plated vias in one example, and the ground legs 221A and 221B can be soldered or otherwise electrically connected to the plated vias or other conductive traces on the PCB 14.

FIG. 7D illustrates the plug interface assembly 210 shown in FIG. 7A, with the shield body 220 omitted from view. The plug body insulator 230 can be formed from an insulating material, such as a plastic or polymer, a thermoplastic resin, LCP, a glass fiber epoxy compound, PTFE, polyimide, or other insulating material(s). The plug body insulator 230 electrically insulates and isolates the plug contact blade 250 from the plug shield body 220. The plug body insulator 230 also mechanically supports and centrally positions the plug contact blade 250 within plug shield body 220. The plug body insulator 230 can be molded around the plug contact blade 250, at least in part, in one example. More particularly, the plug body insulator 230 can be molded around the plug contact blade 250, with the blade end 255 (or at least some portion thereof) being exposed and extending out from the contact end of the plug body insulator 230. The mount contact 253 of the plug contact blade 250 can also be exposed and extend out from the mounting end of the plug body insulator 230, as shown in FIG. 6C. After the plug body insulator 230 is molded around the plug blade contact 250, the molding assembly can be sheared out from a larger lead frame including the plug blade contact 250, among others.

The plug body insulator 230 may also include a number of insulating finger extensions, such as in the example shown, two of which are referenced as the insulating finger extensions 234A and 234B in FIG. 7D. The insulating finger extensions 234A and 234B extend from the plug body insulator 230 at the contact end of the plug body insulator 230. The insulating finger extensions 234A and 234B are separated from each other, with a space between them. When the plug shield body 220 is inserted into the receptacle shield body 120, the beam covers 144A and 144B of the receptacle contact insulator 140 (see FIG. 6D) will fit between the insulating finger extensions 234A and 234B.

FIG. 8 illustrates an example of the receptacle contact 150 in the receptacle interface assembly 110 shown in FIG. 6A. The receptacle contact 150 is representative and not drawn to any particular scale. The receptacle contact 150 can vary as compared to that shown in some cases, such as in length, width, or other aspects. The receptacle contact 150 can be formed from an electrically-conductive, metallic material, such as aluminum, copper, or other conductive metals or alloys thereof. In one example, a number of receptacle contacts, including the receptacle contact 150, can be stamped or sheared out from a sheet of the electrically-conductive, metallic material, forming a lead frame assembly of receptacle contacts. A number of receptacle body insulators, including the receptacle body insulator 130, can be molded around the lead frame assembly of receptacle contacts. After molding, individual contact and body insulator assemblies can be sheared out from the lead frame, and FIG. 6E illustrates an example of one such assembly.

The receptacle contact 150 includes a mount contact 153 at the mounting end 152, a contact beam 154, and a contact head 158. The contact head 158 extends to the contact end 151 of the receptacle contact 150. The contact beam 154 extends between the mount contact 153 and the contact head 158. The contact beam 154 includes lead frame extensions 154A and 154B, which are formed when the contact and body insulator assemblies are sheared out from a larger lead frame, as described above. The contact beam 154 also includes a flow-through aperture 154C. When the receptacle body insulator 130 is molded around the receptacle contact 150, the insulating material of the receptacle body insulator 130 can flow through the flow-through aperture 154C and cure, so that the receptacle body insulator 130 is secured with the receptacle contact 150.

The contact head 158 of the receptacle contact 150 includes the contact beams 155A and 155B and the contact circlets 157A and 157B at the ends of the contact beams 155A and 155B, respectively. A beam channel 156 extends between and separates the contact beams 155A and 155B along their length of extension. The contact head 158 includes also includes barbs 159A and 159B. The receptacle contact insulator 140 (see FIG. 6D) can engage (e.g., snap or fit over) the barbs 159A and 159B, to help hold the receptacle contact insulator 140 in place over the contact head 158.

FIG. 9 illustrates an example of the plug contact blade 250 in the plug interface assembly 210 shown in FIG. 7A. The plug contact blade 250 is representative and not drawn to any particular scale. The plug contact blade 250 can vary as compared to that shown in some cases, such as in length, width, or other aspects. The plug contact blade 250 can be formed from an electrically-conductive, metallic material, such as aluminum, copper, or other conductive metals or alloys thereof. In one example, a number of plug contact blades, including the plug contact blade 250, can be stamped or sheared out from a sheet of the electrically-conductive, metallic material, forming a lead frame assembly of plug contact blades. A number of plug body insulators, including the plug body insulator 230, can be molded around the lead frame assembly of plug blade contacts. After molding, individual contact and body insulator assemblies can be sheared out from the lead frame, and FIG. 7D illustrates an example of one such assembly.

The plug contact blade 250 includes a mount contact 253 at the mounting end 252, a contact beam 254, and the blade end 255. The blade end 255 extends to the contact end 251 of the plug contact blade 250. The contact beam 254 extends between the mount contact 253 and the blade end 255. The contact beam 254 includes lead frame extensions 254A and 254B, which are formed when the contact blade and body insulator assemblies are sheared out from a larger lead frame, as described above. The contact beam 254 also includes a flow-through aperture 254C. When the plug body insulator 230 is molded around the plug contact blade 250, the insulating material of the plug body insulator 230 can flow through the flow-through aperture 254C, so that the plug body insulator 230 is secured with the plug contact blade 250.

The blade end 255 of the plug contact blade 250 includes the cantilevered blade beam 257. The cantilevered blade beam 257 is cantilevered within the blade end 255 and separated from the remainder of the blade end 255 by the beam clearance area 256. The cantilevered blade beam 257 is centrally positioned within the blade end 255 of the plug contact blade 250 in the example shown, along a longitudinal axis of the plug contact blade 250. The cantilevered blade beam 257 is cantilevered starting from a position toward the contact end 251 of the plug contact blade 250 and extends toward the mounting end 252 of the plug contact blade 250.

FIG. 10 illustrates the receptacle contact 150 shown in FIG. 8 and the plug contact blade 250 shown in FIG. 9, in electrical contact with each other. The arrangement shown in FIG. 10 is representative of how the receptacle contact 150 and the plug contact blade 250 interface with each other, when the connector 10 is arranged as shown in FIG. 1A. As shown, the contact circlets 157A and 157B contact opposing surfaces of the cantilevered blade beam 257. The blade end 255 of the plug contact blade 250 extends into the beam channel 156 between the contact beams 155A and 155B. Although FIG. 10 illustrates the contact circlets 157A and 157B at one position on the cantilevered blade beam 257, the contact circlets 157A and 157B can also contact the cantilevered blade beam 257 at other locations. For example, depending on how far the receptacle assembly 100 is inserted into the plug assembly 200, the contact circlets 157A and 157B can also contact the cantilevered blade beam 257 at other positions.

The cantilevered blade beam 257 is flexible and can bend to some extent based on forces presented by the contact circlets 157A and 157B. Thus, the cantilevered blade beam 257 can help to facilitate misalignments, manufacturing tolerances, and other conditions that may result in forces being presented on the plug contact blade 250 by the contact circlets 157A and 157B. Overall, the cantilevered blade beam 257 is configured to elastically bend to some extent, if needed, as the pair of contact circlets 157A and 157B electrically contact and slide along surfaces of the cantilevered blade beam 257.

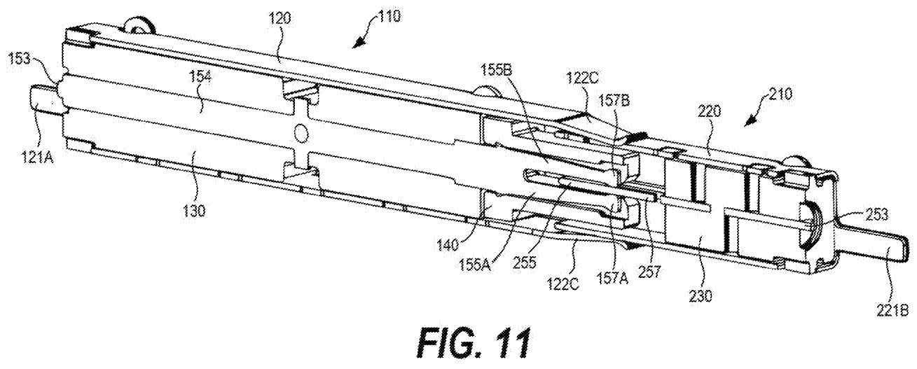

FIG. 11 illustrates the cross-sectional view designated B-B in FIG. 5 according to various embodiments of the present disclosure. Particularly, FIG. 5 illustrates a cross-sectional view of the receptacle interface assembly 110 and the plug interface assembly 210, when they are mated together. The arrangement shown in FIG. 11 is representative of how the receptacle interface assembly 110 and the plug interface assembly 210 interface with each other, when the connector 10 is arranged as shown in FIG. 1A.

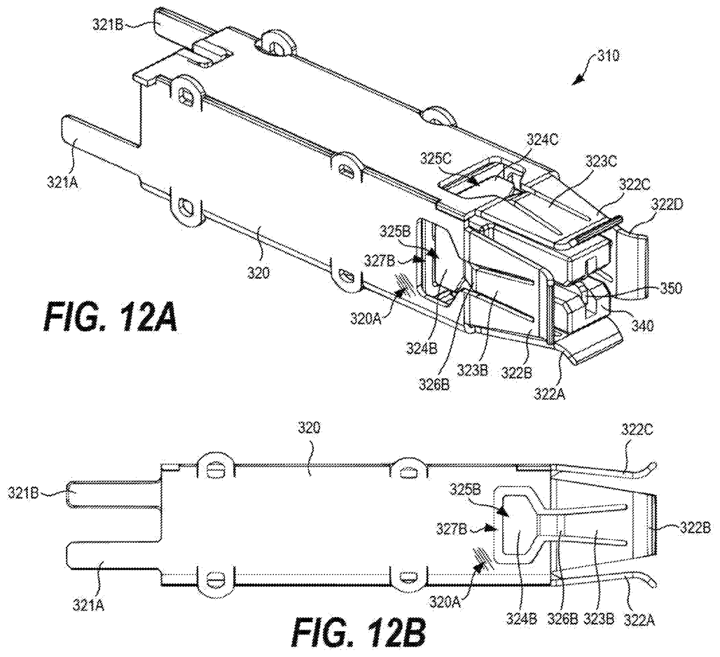

Turning to other aspects of the embodiments, FIG. 12A illustrates a perspective view of another example receptacle interface assembly 310 that can be used in a board-to-board array connector according to various embodiments of the present disclosure. FIG. 12B illustrates a side view of the receptacle interface assembly 310 shown in FIG. 12A. The receptacle interface assembly 310 is not drawn to any particular scale and is illustrated to provide context for the concepts of the board-to-board array connectors described herein. The receptacle interface assembly 310 can be formed in a range of different shapes, styles, and sizes, although certain sizes and shapes are described and illustrated. The receptacle interface assembly 310 shown in FIG. 12A is similar to the receptacle interface assembly 110 shown in FIG. 6A, although the receptacle interface assembly 310 includes cantilevered shield arms, among other features described below. The receptacle interface assembly 310 is also relatively shorter than the receptacle interface assembly 110, as the board-to-board array connectors can vary in size according to the embodiments.

The receptacle interface assembly 310 includes a receptacle shield body 320, a receptacle body insulator positioned within the receptacle shield body 320, a receptacle contact insulator 340, and a receptacle contact 350 that extends within the receptacle shield body 320. The receptacle body insulator and the receptacle contact 150 are similar to the receptacle body insulator 130 and the receptacle contact 150 described above.

The receptacle shield body 320 can be formed from an electrically-conductive, metallic material, such as aluminum, copper, or other conductive metals or alloys thereof. In one example, the receptacle shield body 320 can be stamped or sheared out from a sheet of the electrically-conductive, metallic material, and then be bent or otherwise formed into the shape shown in FIGS. 12A and 12B. The receptacle shield body 320 is generally formed as a hollow, rectangular cuboid, with rounded corners. The receptacle shield body 320 includes the ground legs 321A and 321B at a mounting end. The receptacle shield body 320 also includes a number of compliant extension contacts 322A-322D at a contact end. Each of the compliant extension contacts 322A-322D extends from one side surface of the receptacle shield body 320.

The plug shield body 220 of the plug interface assembly 210 (see FIG. 5), for example (or a similar plug interface assembly), can be inserted into the receptacle shield body 320 at the contact end, and the inner surfaces of the compliant extension contacts 322A-322D will contact the outer surfaces of the plug shield body 220, making an electrical contact between them. The shield bodies 320 and 220 provide an EMI shield for the RF signal carried on the contacts within them.

The receptacle shield body 320 also includes a number of cantilevered shield arms. As examples, the cantilevered shield arms 325B and 325C of the receptacle shield body 320 are shown in FIG. 12A. Although not visible in FIG. 12A or 12B, the receptacle shield body 320 includes cantilevered shield arms corresponding to each of the compliant extension contacts 322A-322D. The cantilevered shield arm 325B includes a compliant arm 323B and a shield paddle 324B. The cantilevered shield arm 325B is cantilevered at a position within the compliant extension contact 322B and extends toward the mounting end of the receptacle shield body 320. Similarly, the cantilevered shield arm 325C includes a compliant arm 323C and a shield paddle 324C. The cantilevered shield arm 325C is cantilevered at a position within the compliant extension contact 322C and extends toward the mounting end of the receptacle shield body 320.

The compliant arm 323B includes a bend 326B. Starting from the end closest to the contact end of the receptacle shield body 320, the compliant arm 323B generally extends parallel to (or in the same plane as) the compliant extension contact 322B until meeting the bend 326B. After the bend 326B, the compliant arm 323B angles to extend further toward the center of the receptacle shield body 320. The shield paddle 324B joins the compliant arm 323B at the distal end of the compliant arm 323B. A shield clearance area 327B separates the cantilevered shield arm 325B from the remainder of the receptacle shield body 320, so that the cantilevered shield arm 325B can bend. The cantilevered shield arm 325B, and other cantilevered shield arms of the receptacle shield body 320, are similarly formed.

The shield paddle 324B is cut out (i.e., separated) from the side 320A of the receptacle shield body 320. The shield paddle 324C, among shield paddles, are also cut out from other sides of the receptacle shield body 320. The shield paddles 324B and 324C, among others, are positioned around the receptacle contact insulator 340, which is positioned within the receptacle shield body 320. Generally, the shield paddle 324B is located closer to the center of the receptacle shield body 320 than the side 320A of the receptacle shield body 320, and the shield paddle 324C is also located closer to the center of the receptacle shield body 320. Overall, the shield paddles of the cantilevered shield arms can help to provide improved return loss performance in some cases as compared to other designs.

The plug shield body 220 of the plug interface assembly 210 (see FIG. 5), for example (or a similar plug interface assembly), can be inserted into the receptacle shield body 320 at the contact end. In that case, the inner surfaces of the compliant extension contacts 322A-322D of the receptacle shield body 320 will contact the outer surfaces of the plug shield body 220, making an electrical contact between them. Additionally, depending upon the extent (e.g., distance) that the plug shield body 220 is inserted into the receptacle shield body 320, the outer surfaces of the plug shield body 220 will contact the inner surfaces of the cantilevered shield arms 325B and 325° C., among those of other cantilevered shield arms. The cantilevered shield arms 325B and 325C are flexible and can bend to some extent based on forces presented by the outer surfaces of the plug shield body 220. In turn, the shield paddles 324B and 324C, among others, may move from the position shown in FIG. 12A. Particularly, if the plug shield body 220 is inserted far enough into the receptacle shield body 320, the shield paddles 324B and 324C may be pushed further out from the center of the receptacle shield body 320.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or related metric of deviation, account for at least some manufacturing tolerances between a theoretical design and a manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

1. A board-to-board array connector, comprising:
a receptacle assembly, the receptacle assembly comprising a receptacle housing and a plurality of receptacle interface assemblies; and
a plug assembly, the plug assembly comprising a plug housing and a plurality of plug interface assemblies, a plug interface assembly among the plurality of plug interface assemblies comprising
a plug contact blade having a cantilevered blade beam.

2. The board-to-board array connector of claim 1, wherein the cantilevered blade beam of the plug contact blade is centrally positioned within the plug contact blade.

3. The board-to-board array connector of claim 1, wherein the cantilevered blade beam of the plug contact blade is cantilevered toward a contact blade end of the cantilevered blade beam and extends toward a mount end of the cantilevered blade beam.

4. The board-to-board array connector of claim 1, wherein:
a receptacle interface assembly among the plurality of receptacle interface assemblies comprises
a receptacle contact; and
the receptacle contact comprises a pair of contact beams.

5. The board-to-board array connector of claim 4, wherein, when the receptacle assembly is connected with the plug assembly, each contact beam among the pair of contact beams electrically contacts a respective side surface of the cantilevered blade beam.

6. The board-to-board array connector of claim 4, wherein the cantilevered blade beam is configured to bend as the pair of contact beams electrically contact and slide along surfaces of the cantilevered blade beam.

7. The board-to-board array connector of claim 1, wherein a receptacle interface assembly among the plurality of receptacle interface assemblies comprises:
a receptacle shield body;
a receptacle body insulator; and
a receptacle contact comprising contact beams, wherein the receptacle body insulator electrically isolates the receptacle contact from the receptacle shield body.

8. The board-to-board array connector of claim 7, wherein the receptacle body insulator comprises chamfered corners.

9. The board-to-board array connector of claim 1, wherein the plug interface assembly further comprises:
a plug shield body; and
a plug body insulator, wherein the plug body insulator electrically isolates the plug contact blade from the plug shield body.

10. The board-to-board array connector of claim 1, wherein:
a receptacle interface assembly among the plurality of receptacle interface assemblies further comprises a receptacle shield body,
the receptacle shield body comprises a plurality of compliant extension contacts at a contact end of the receptacle shield body, and
a compliant extension contact among the plurality of compliant extension contacts comprises a cantilevered shield arm.

11. The board-to-board array connector of claim 10, wherein the cantilevered shield arm is cantilevered toward a contact end of the receptacle shield body extends toward a mount end of the receptacle shield body.

12. The board-to-board array connector of claim 10, wherein the cantilevered shield arm comprises a compliant arm and a shield paddle.

13. The board-to-board array connector of claim 12, wherein the shield paddle is separated from the receptacle shield body by a shield clearance area.

14. The board-to-board array connector of claim 12, wherein the shield paddle is configured to bend from a position further toward a center of the receptacle shield body to a position further away from the center of the receptacle shield body.

15. A board-to-board array connector, comprising:
a receptacle assembly, the receptacle assembly comprising a receptacle housing and a plurality of receptacle interface assemblies, wherein:
a receptacle interface assembly among the plurality of receptacle interface assemblies comprises
a receptacle shield body having a compliant extension contact, and the compliant extension contact comprises a cantilevered shield arm.

16. The board-to-board array connector of claim 15, wherein the cantilevered shield arm is cantilevered toward a contact end of the receptacle shield body extends toward a mount end of the receptacle shield body.

17. The board-to-board array connector of claim 15, wherein the cantilevered shield arm comprises a compliant arm and a shield paddle.

18. The board-to-board array connector of claim 17, wherein the shield paddle is separated from the receptacle shield body by a shield clearance area.

19. The board-to-board array connector of claim 17, wherein the shield paddle is configured to bend from a position further toward a center of the receptacle shield body to a position further away from the center of the receptacle shield body.

20. The board-to-board array connector of claim 15, further comprising:
a plug assembly, the plug assembly comprising a plug housing and a plurality of plug interface assemblies, a plug interface assembly among the plurality of plug interface assemblies comprising a plug contact blade having a cantilevered blade beam.
